(19) United States
(12) Patent Application Publication
(10) Pub. No.: US 2020/0326952 A1
(43) Pub. Date: Oct. 15, 2020

(54) MODIFICATION PROCEDURE GENERATION DEVICE, MODIFICATION PROCEDURE GENERATION METHOD AND STORAGE MEDIUM FOR STORING MODIFICATION PROCEDURE GENERATION PROGRAM

(71) Applicant: NEc Corproation, Minato-ku, Tokyo (JP)

(72) Inventor: Manabu NAKANOYA, (US)

(73) Assignee: NEC Corporation, Minato-ku, Tokyo (JP)

(21) Appl. No.: 16/082,096

(22) PCT Filed: Mar. 3, 2017
(86) PCT No.: PCT/JP2017/008439

§ 371 Date: Sep. 4, 2018

(30) Foreign Application Priority Data
Mar. 10, 2016 (JP) 2016-046526

(51) Int. Cl. G06F 9/445; G06F 11/14

(52) U.S. Cl. CPC G06F 9/445; G06F 11/142

(57) ABSTRACT

The modification procedure generation device according to an aspect of the present invention includes: elimination unit that eliminates states other than states that satisfy a predetermined condition from states including states of elements of a system undergoing modification based on a predetermined modification requirement, the predetermined condition pertaining to the system undergoing modification.

### TECHNICAL FIELD

The present invention relates to a modification procedure generation device, a modification procedure generation method, and a storage medium storing a modification procedure generation program.

### BACKGROUND ART

The objective of modification management is to reduce time and labor of an administrator and a modification operator of a system to be modified and influence on users of the system to be modified, which arise when the system is modified. When a system to be modified is, for example, a complicated system implemented using a plurality of parts, the modification operations become complicated. As the modification operations become complicated, time and labor of an operator and an administrator who oversees operations of the operator increases. As the result, influence on users of the system also increases.

In particular, the operations are likely to be complicated when there is dependency between parts included in a system because order matters to the modification operations on the parts. The dependency between parts is a relationship between two elements, for example, for a part A and a part B, the part A requires the part B to function properly in order to function properly.

In the case of the example described above, the part A is described as depending on the part B. In operations of implementing a system including the part A and the part B, the operations are required to be performed in order. For example, the part B is implemented first, and then the part A is implemented.

A system that automatically generates a plan of operations required for modification of a system while taking into account dependency as described above is referred to as a modification management system. Information on dependency between parts and information on operations on parts are defined in advance in the modification management system.

Using the above-mentioned modification management system, an administrator can efficiently generate an operation procedure that is effective for performing complicated modification operations. In addition, an operator can efficiently perform the operations in accordance with the generated effective operation procedure. As the result, influence on users of the system to be modified is expected to be reduced.

With regard to the modification management system as described above, a number of related studies and related products are known. For example, PTL 1 describes a change planning system that defines operating states of parts and dependency between the states and generates a change procedure required for change operations.

In a method of illustrating states of parts and dependency between the states in a state transition diagram, it is in general important to select a method of appropriately converting design information of a system into a state transition diagram. PTL 2 describes a modification management system that efficiently converts design information of a model including states into a state transition diagram that can be easily processed.

Further, NPL 1 describes a technique of modifying the configuration of a target system when only configuration parameters of parts and a configuration order are provided.

Further, NPL 2 and NPL 3 prescribe a life cycle framework that is used not only for modifying a system configuration but also for constructing a system. In the prescribed framework, a system modification procedure is assumed to be provided by an external factor such as a user input.

NPL 4 describes a technique of defining behavior of each part in modification as, for example, “replacement”, “No Interruption” or the like when deriving a modification procedure, and operating in accordance with the definition under modification.

In addition, PTL 3 describes a workflow definition changing method including checking whether consistency exists between two or more processing procedures and presenting a correct workflow when consistency does not exist.

### CITATION LIST

### Patent Literature

[PTL 1] Japanese Unexamined Patent Application Publication No. 2015-215885

[PTL 2] Japanese Unexamined Patent Application Publication No. 2015-215887

[PTL 3] Publication of Japanese Patent No. 5229223

### Non Patent Literature

[NPL 1] “An Overview of Chef”, [online], CHEF DOCUMENTS, [Searched on Feb. 16, 2015], Internet <http://docs.opscode.com/chef_overview.html>

[NPL 2] “OASIS Topology and Orchestration Specification for Cloud Applications”, [online], OASIS, [Searched on Feb. 16, 2015], Internet <https://www.oasis-open.org/committees/tc_home.php?wg_abbrev=tosca#overview>

[NPL 3] “Network Functions Virtualisation (NFV); Management and Orchestration”, [online], ETSI, [Searched on Feb. 16, 2015], Internet <http://www.etsi.org/deliver/etsi_gs/NFV-MAN/001_099/001/01.01.01_60/gs_NFV-MAN001v010101p.pdf>

[NPL 4] “AWS CloudFormation”, [online], AWS, [Searched on Feb. 16, 2015], Internet <http://aws.amazon.com/cloudformation/>

### SUMMARY OF INVENTION

### Technical Problem

The change planning system described in PTL 1 is a system that derives a modification procedure for modifying a system into a final state that is required by a user. However, PTL 1 does not particularly prescribe how to deal with the state of the system in the midst of modification. For such a reason, the change planning system described in PTL 1 is not able to generate a modification procedure that takes into account a variety of requirements for availability, throughput, resource utilization rates, or the like of a system in the midst of modification, which may possibly be execution requirements of system modification.

The method described in NPL 1 and the method described in NPL 4 are methods that derive a modification procedure focusing only on the system states of before and after modification. Thus, the method described in NPL 1 and the method described in NPL 4 either are not able to derive a modification procedure that takes into account requirements for a system in the midst of modification.

The framework described in NPL 2 and the framework described in NPL 3 allow flexible description of a modification method and, thus, allow description of requirements for a transient state of a system. However, in the frameworks described in NPL 2 and the frameworks described in NPL 3, management of a system configuration is not assumed to be associated directly with derivation of a modification procedure.

In other words, a user is required to manually input a modification procedure, and, thus, patterns of modification and amount of modification that can be dealt with depend on a user in charge of the operation. When the framework described in NPL 2 or the framework described in NPL 3 is used, patterns of modification and amount of modification that can be dealt with are restricted.

The workflow definition modification method described in PTL 3 aims to solve a competition between a plurality of different modification procedures, but does not aim to derive a modification procedure for a single modification objective.

An objective of the present invention is to provide a modification procedure generation device, a modification procedure generation method, and a storage medium storing a modification procedure generation program that can solve the above-described problem, and generate a modification procedure taking into account a requirement for a system in the midst of modification.

### Solution to Problem

The modification procedure generation device according to an aspect of the present invention includes elimination means for eliminating states other than states that satisfy a predetermined condition from states including states of elements of a system undergoing modification based on a predetermined modification requirement, the predetermined condition pertaining to the system undergoing modification.

A modification procedure generation method according to an aspect of the present invention includes eliminating states other than states that satisfy a predetermined condition from states including states of elements of a system undergoing modification based on a predetermined modification requirement, the predetermined condition pertaining to the system undergoing modification.

A storage medium according to an aspect of the present invention stores a modification procedure generation program that causes a computer to execute elimination processing of eliminating states other than states that satisfy a predetermined condition from states including states of elements of a system undergoing modification based on a predetermined modification requirement, the predetermined condition pertaining to the system undergoing modification.

### Advantageous Effects of Invention

According to the present invention, a modification procedure that takes into account a requirement for a system in the midst of modification can be generated.

### BRIEF DESCRIPTION OF DRAWINGS

FIG. 1 is a block view illustrating a configuration example of a modification procedure generation device according to a first example embodiment of the present invention.

FIG. 2 is an explanatory view illustrating an example of input information of the present example embodiment.

FIG. 3 is an explanatory view illustrating an example of models that are expanded from input information by a model expansion unit according to the present example embodiment.

FIG. 4 is an explanatory view illustrating an example of a logical state element that is generated from input information by a logical state generation unit according to the present example embodiment.

FIG. 5 is an explanatory view illustrating an example of nodes generated by a state transition diagram generation unit according to the present example embodiment.

FIG. 6 is an explanatory view illustrating an example of a state transition diagram generated by the state transition diagram generation unit according to the present example embodiment.

FIG. 7 is an explanatory view illustrating another example of nodes generated by the state transition diagram generation unit according to the present example embodiment.

FIG. 8 is an explanatory view illustrating another example of a state transition diagram generated by the state transition diagram generation unit according to the present example embodiment.

FIG. 9 is an explanatory view illustrating an example of a modification procedure derived from input information by a procedure deriving unit according to the present example embodiment.

FIG. 10 is a flowchart illustrating operation of modification procedure generation processing by the modification procedure generation device of the present example embodiment.

FIG. 11 is a block view illustrating a configuration example of a modification procedure generation device according to a second example embodiment of the present invention.

FIG. 12 is a flowchart illustrating operation of restoration processing by the modification procedure generation device of the present example embodiment.

FIG. 13 is a block view illustrating an overview of a modification procedure generation device according to a third example embodiment of the present invention.

FIG. 14 is a block view illustrating a hardware configuration example of a computer that can realize the functional units of the modification procedure generation device according to the example embodiments of the present invention.

### DESCRIPTION OF EMBODIMENTS

### First Example Embodiment

### (Description of Configuration)

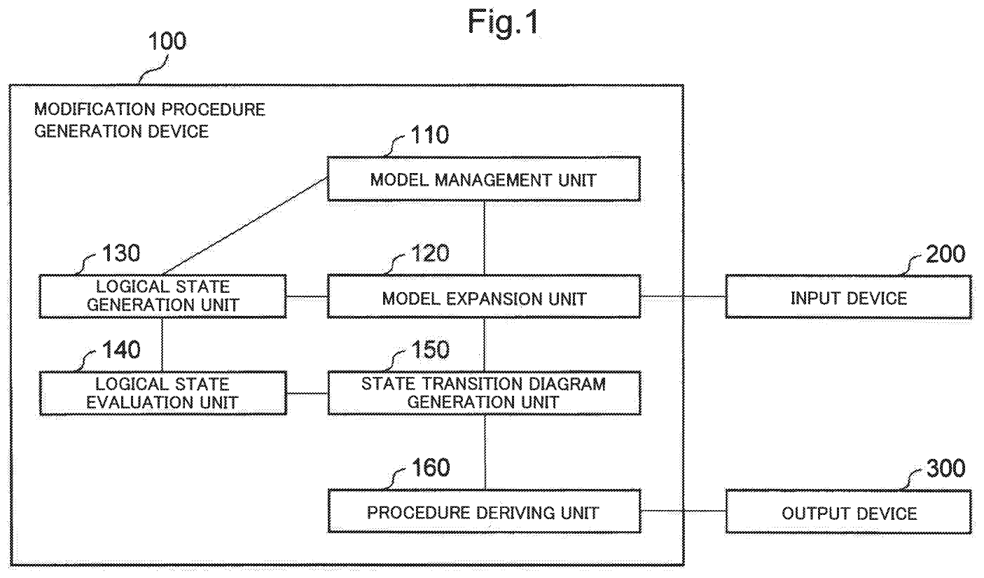

The following describes an example embodiment of the present invention with reference to the drawings. FIG. 1 is a block view illustrating a configuration example a first example embodiment of a modification procedure generation device 100 according to the present invention.

As illustrated in FIG. 1, the modification procedure generation device 100 of the present example embodiment includes a model management unit 110, a model expansion unit 120, a logical state generation unit 130, a logical state evaluation unit 140, a state transition diagram generation unit 150, and a procedure deriving unit 160.

Further, as illustrated in FIG. 1, the modification procedure generation device 100 is communicably connected with an input device 200 that inputs information to the modification procedure generation device 100. The modification procedure generation device 100 is also communicably connected with an output device 300 that outputs a modification procedure generated by the modification procedure generation device 100.

The modification procedure generation device 100 may not be communicably connected with the input device 200 or the output device 300. The modification procedure generation device 100 is a standalone device.

By using a final state of a system, which is required by a user, and a requirement for the system, which is required to be satisfied during modification of the system, as an input, the modification procedure generation device 100 of the present example embodiment generates a modification procedure by which all the states from a state in the midst of modification of the system to a state of after completion of the modification satisfy a predetermined condition.

In the present example embodiment, a requirement for a system, which is required to be satisfied during modification of the system, is represented by, for example, a combination of states of component parts of the system of before modification and states of the component parts of the system of after modification. The combination of the states of the component parts of the system is represented by, for example, a element included in a subset of a Cartesian product concerning all the states that all the component parts of the system may take. Hereinafter, the requirement for a system, which is required to be satisfied during modification of the system, is also referred to as a requirement for the states of components, which is required to be satisfied during modification of the system, a requirement for the state of the system under modification, a requirement for the state under modification, and a requirement under modification. The requirement for a system, which is required to be satisfied during modification of the system, may also be referred to as a transient state requirement.

When the requirement for a system, which is required to be satisfied during modification of the system, is specified, the modification procedure generation device 100 derives a modification procedure that is considered in such a way that the state of the system under modification satisfies a predetermined condition.

The model management unit 110 has a function of recording states of components of a system and a dependency relationship between the states. The model management unit 110 further records a component of which state depends on a combination of states of components of a system. Hereinafter, the component of which state depends on a combination of states of other components is referred to as a logical state element in order to distinguish it from the other components.

The model management unit 110 retains a condition under which a state of a logical state element is true, for example, in a form of a function or logical expression that takes the states of components of a system as input and returns a true or false value. The model management unit 110 manages, in a reusable manner, specific information which is required for deriving a modification procedure. The specific information is, for example, a specific format of a modification procedure of components, a property corresponding to a configuration value for modification, and a dependency relationship between components, which is required to be considered upon modification.

The model expansion unit 120 has a function of listing specific state models and dependency relationships therebetween on the basis of components of a system, states of the components of the system of before and after modification, and a transient state requirement which represents a requirement under modification and in which a logical state element is specified. Hereinafter, listing specific state models and dependency relationships therebetween is referred to as model expansion. That is, the model expansion unit 120 expands models by adding the information to the input components of the system on the basis of specific information that is managed by the model management unit 110 and required for derivation of a modification procedure.

When expanding models, the model expansion unit 120 integrates the input information and information recorded in the model management unit 110. Specifically, the model expansion unit 120 refers to model information, registered in the model management unit 110, of the input system components. The model expansion unit 120 completes the system components required for deriving a modification procedure by compensating accompanying elements required for modification of the system and dependency relationships between the elements under modification.

The logical state generation unit 130 has a function of embodying a relationship between a target system for which a modification procedure is to be generated and a logical state element by integrating a transient state requirement, which is input from the model expansion unit 120, and information of the logical state element for the transient state requirement, which is recorded in the model management unit 110.

When a function or a logical expression, which specifies the state of a logical state element, is registered in the model management unit 110, the logical state generation unit 130 identifies components to be given to the function or logical expression from among the input components of the target system for which a modification procedure is to be generated. When identifying is completed, the logical state generation unit 130 stores a specific logical state element of which state is calculated for each state of the target system for which a modification procedure is to be generated.

The logical state evaluation unit 140 has a function of calculating a state of a logical state element generated by the logical state generation unit 130 for each state of the target system for which a modification procedure is to be generated. The logical state evaluation unit 140 identifies a node that does not satisfy a transient state requirement from among nodes included in a state transient diagram of the entirety of the system, for example, using a determination expression that defines a state of a given logical state element.

The state transition diagram generation unit 150 has a function of generating a state transition diagram of a system while taking into account the input transient state requirement on the basis of state models input from the model expansion unit 120 and a determination result of conformity, to a transient state requirement, of each state of the system by the logical state evaluation unit 140.

The state transition diagram generation unit 150 stores states that the system may take and is input on the basis of a combination of states to which the components of the system can make transition. Next, the state transition diagram generation unit 150 restricts the states that the system may take using the result of determination whether the requirement under modification is satisfied by the logical state evaluation unit 140.

A node included in the state transition diagram of the present example embodiment is an element included in a subset of a Cartesian product concerning all of the states that any of the components of the system may take. The subset which is of the Cartesian product and which includes an element corresponding to a node is a set acquired by eliminating an element having a state to which transition is not possible to make from among a simple Cartesian product of all of the states that any of the components may take.

An edge included in the state transition diagram of the present example embodiment is an edge that links nodes between which a transition can be made in at least one direction, i.e. a direction from one node to the other node, and each of which includes components including one component that differs in its state.

When generating a state transition diagram, the state transition diagram generation unit 150 checks whether each node included in the state transition diagram satisfies a transient state requirement. When there is a node that does not satisfy the transient state requirement, the state transition diagram generation unit 150 eliminates the node that does not satisfy the transient state requirement from the state transition diagram.

Determination of whether each node satisfies a transient state requirement is performed by the logical state evaluation unit 140 having received states of components included in a determination target node from the state transition diagram generation unit 150. The state transition diagram generation unit 150 acquires the determination result from the logical state evaluation unit 140, and eliminates a node determined not to satisfy the transient state requirement from the state transition diagram.

The procedure deriving unit 160 has a function of deriving a modification procedure on the basis of the state transition diagram generated by the state transition diagram generation unit 150. The procedure deriving unit 160 is capable of solving a problem of deriving a modification procedure from the state transition diagram as a shortest path problem of acquiring a shortest path in a directed graph.

The procedure deriving unit 160 is capable of deriving a modification procedure, for example, using an existing algorithm, such as a Dijkstra's algorithm, for solving a shortest path problem. The algorithm used by the procedure deriving unit 160 may be any algorithm that can solve a shortest path problem.

The modification procedure generation device 100 of the present example embodiment is capable of generating a modification plan that satisfies a requirement for the states under modification on the basis of state machines including a transition condition and a transient state requirement. A user can generate a modification procedure using the modification procedure generation device 100, for example, in the following manner.

A user registers a component part model including a state machine and a logical state element model that describes a transient state requirement in the model management unit 110 of the modification procedure generation device 100. Next, the user inputs a current state of a system that is a target of modification, a state of the system of after modification, and a requirement for a state of the system under modification into the input device 200.

The input information of the present example embodiment includes, for example, a component of a system for which a modification procedure is to be derived, a current state of the component, a component of the system and a states of the components of after modification, and a component of the system and a state that the component may take in the midst of modification.

Next, the input device 200 transmits a predetermined system configuration and a transient state requirement that are acquired by combining the registered models as a modification requirement to the model expansion unit 120. The model expansion unit 120 receives the transmitted modification requirement. The model expansion unit 120 inputs the received modification requirement to the logical state generation unit 130. The model expansion unit 120 and the logical state generation unit 130, which are provided with the modification requirement, generate model information on the basis of the information registered in the model management unit 110.

Next, the state transition diagram generation unit 150 generates a state transition diagram while taking into account the determination result of conformity, to the transient state requirement, of each state of the system calculated by the logical state evaluation unit 140. As described above, deriving a modification procedure on the basis of the state transition diagram generated by the state transition diagram generation unit 150 corresponds to solving a shortest path problem. Next, the procedure deriving unit 160 derives a modification procedure by solving a shortest path problem.

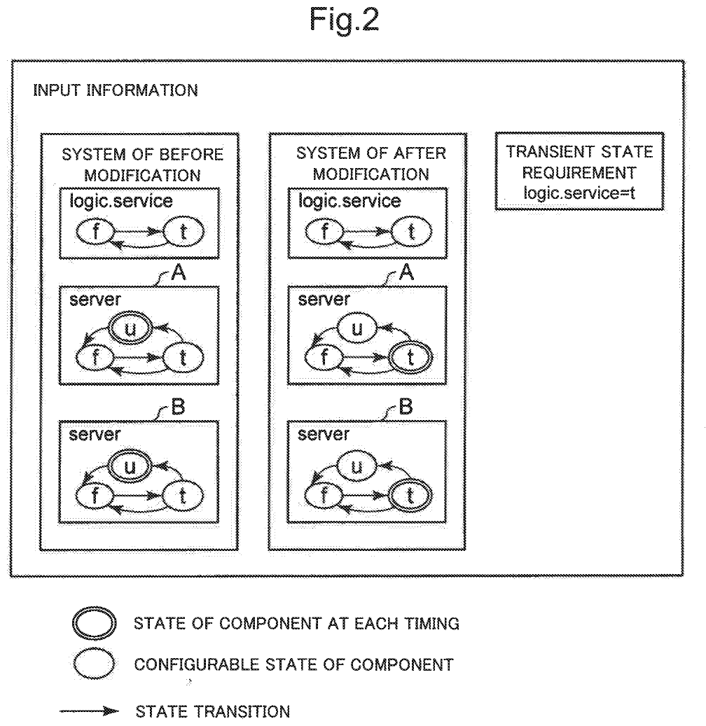

As described above, the modification procedure generation device 100 of the present example embodiment is capable of deriving a modification procedure for modifying a state of a system to a required state while maintaining the state of the system under modification to satisfy a specified requirement, when at least one predefined requirement for the state of the system under modification is only specified. The following describes a specific example of generating a modification procedure by the modification procedure generation device 100 of the present example embodiment with reference to FIGS. 2 to 9.

FIG. 2 is an explanatory view illustrating an example of input information of the present example embodiment. The input information illustrated in FIG. 2 includes information indicating a system of before modification, information indicating the system of after modification, and information indicating a transient state requirement. That is, the input information illustrated in FIG. 2 represents a modification requirement.

As illustrated in FIG. 2, the system that is a target of modification includes two servers of ‘server A’ and ‘server B’ that process services. The system that is a target of modification further includes a load balancer that distributes loads to the servers.

As illustrated in FIG. 2, the modification target system includes three components, that is, ‘server A’, ‘server B’ and ‘logic.service’. The ‘server A’ and the ‘server B’ each represent states of servers that process services.

In FIG. 2, an ellipse represents a state that a component may take and a text inside the ellipse represents the name of the state. The state ‘f’ of the ‘server A’ and ‘server B’ represents a stop state of a server. The state ‘t’ represents a state where a server is activated and capable of providing services as a standalone server. The state ‘u’ represents a state where a server is capable of providing services and modification of an installed application or the like is required.

An arrow that connects ellipses in FIG. 2 represents a state transition. That is, a state of a component can make a transition to another state that is connected by an arrow. For example, as illustrated in FIG. 2, the state ‘u’ can make a transition only to the state ‘f’.

The ‘logic.service’ is a component representing whether the entirety of the system can provide services. The ‘logic.service’ is a component of which state depends on a combination of states of other components, thus, is a logical state element.

A state of ‘logic.service’ that is a logical state element depends on a combination of states of other components as is described below. For example, if the state of at least one of ‘server A’ and ‘server B’ is the state ‘t’, the entirety of the system is capable of providing services, and the state of ‘logic.service’ that is a logical state element is considered to be defined as the state ‘t’.

If the state of ‘server A’ and the state of ‘server B’ are both the state ‘f’, the system as a whole is not able to provide services, and the state of the ‘logic.service’ as a logical state element is considered to be defined as the state ‘f’. In general, a function that takes the components of a system (m(1) . . . m(n)) as an input and returns a Boolean value (true or false) is defined as information indicating a state of a logical state element in such a way that the function takes the components of a system as an input and returns a Boolean value (e.g. true or false).

In FIG. 2, an ellipse in a double line represents a state of a component at a timing. Each of the systems of before and after modification illustrated in FIG. 2 includes a state of a component at a timing.

For example, as illustrated in FIG. 2, the state of ‘server A’ included in the system of before modification is the state ‘u’. As illustrated in FIG. 2, the state of the ‘server A’ included in the system of after modification is the state ‘t’. That is, it is understood from the input information illustrated in FIG. 2 that a procedure of modifying the state of ‘server A’ from the state ‘u’ to the state ‘t’ is partially derived.

The transient state requirement of the present example embodiment is a requirement for a state of a component and is required to be satisfied during modification of a system. The transient state requirement illustrated in FIG. 2 requires the state of logic.service' that is a logical state element to be the state ‘t’ during modification of the system.

That is, the input information illustrated in FIG. 2 is input information indicating a request to execute update of each of the servers while maintaining provision of services by the servers that are multiplexed. An operation of updating the servers includes an operation of stopping a server and an operation of activating a server.

When receiving input information as illustrated in FIG. 2, the model expansion unit 120 expands models using information that is registered in advance in the model management unit 110.

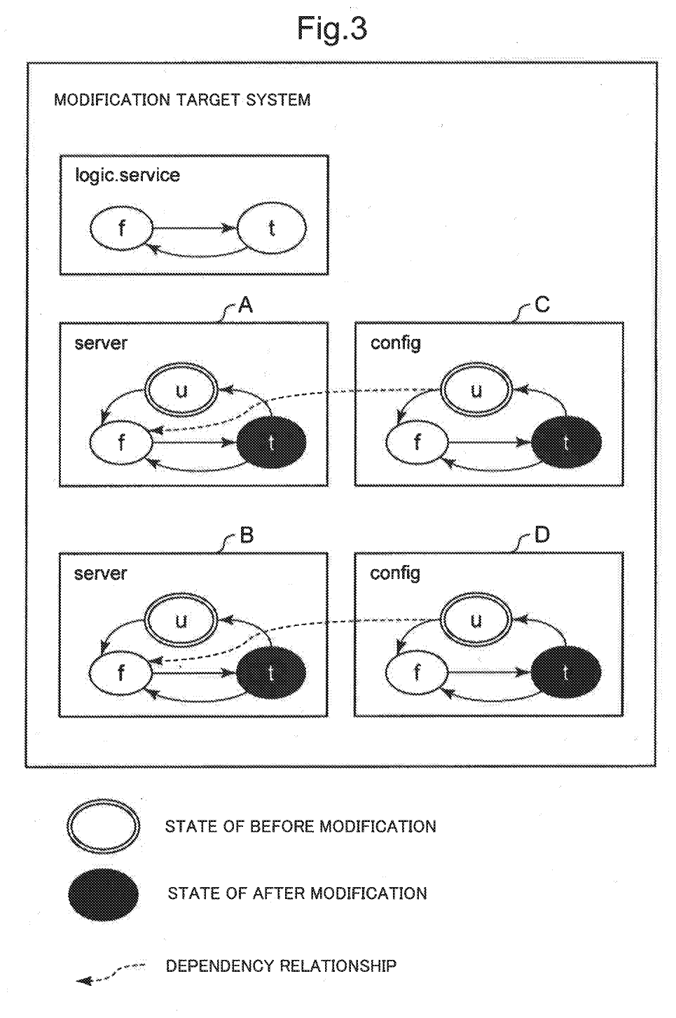

FIG. 3 is an explanatory view illustrating an example of models that are expanded from input information by the model expansion unit 120. The models illustrated in FIG. 3 are models that are expanded from the input information illustrated in FIG. 2 and represent a modification target system and a modification requirement. In FIG. 3 a ellipse in a double line represents a state of before modification and a black ellipse represents a state of after modification. In addition, in FIG. 3, an arrow in a broken line represents a dependency relationship.

When expanding models, the model expansion unit 120 refers to the state of each component of before modification of the system and of after modification of the system and information managed by the model management unit 110. As illustrated in FIG. 3, the model expansion unit 120 having referred to the information appends information indicating an element required for modifying a state of a component and dependency between components to an expanded model.

For example, FIG. 3 indicates that there is a dependency relationship between the state ‘u’ of ‘config C’ and the state ‘f’ of ‘server A’. That is, the state of ‘server A’ is required to be the state ‘f’ when the state of ‘config C’ makes a transition from the state ‘u’ to the state ‘f’.

FIG. 3 also indicates that there is a dependency relationship between the state ‘u’ of ‘config D’ and the state ‘f’ of ‘server B’. That is, the state of ‘server B’ is required to be the state ‘f’ when the state of ‘config D’ makes a transition from the state ‘u’ to the state ‘f’.

The model expansion unit 120 transmits the input information indicating the logical state element and transient state requirement to the logical state generation unit 130. The logical state generation unit 130 retrieves information of the logical state element which is registered in the model management unit 110 and corresponds to the received information. Using the retrieved information, the logical state generation unit 130 generates a concrete logical state element.

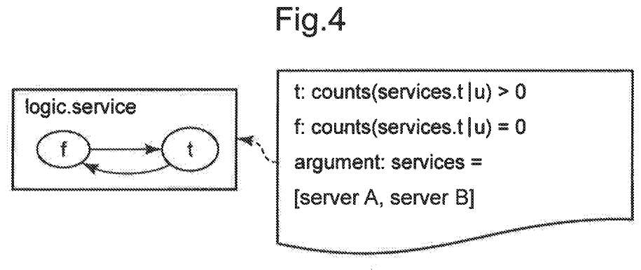

FIG. 4 is an explanatory view illustrating an example of the logical state element that is generated from the input information by the logical state generation unit 130. The logical state element illustrated in FIG. 4 is a logical state element generated from the input information illustrated in FIG. 2.

FIG. 4 illustrates a definition of states of a logical state element that is indicated by the information retrieved from the model management unit 110. For example, in the right block in FIG. 4, “t: counts(services.tlu)>0” and “f: counts(services.tlu)=0” are described. The term “counts(services.tlu)” means the number of components of which state is the state ‘t’ or the state ‘u’ in the components indicated by the input information.

The term “t: counts(services.tlu)>0” indicates that the state of ‘logic.service’ that is a logical state element is the state ‘t’ when there is at least one component of which state is the state ‘t’ or the state ‘u’. The term “f: counts(services.tlu)=0” indicates that the state of ‘logic.service’ is the state ‘f’ when there is no component of which state is the state ‘t’ or the state ‘u’, that is, when the number of such components is 0.

FIG. 4 also illustrates a list of components that are used for determination of the state of the logical state element transmitted from the model expansion unit 120. The term “argument: services=[server A, server B]” described in the right block in FIG. 4 indicates that components used for determination of the state of the logical state element are two components of ‘server A’ and ‘server B’. The logical state generation unit 130 transmits the generated information to the logical state evaluation unit 140.

As described above, the determination expression that defines the state of the logical state element is expressed by a logical disjunction of the state of ‘server A’ and the state of ‘server B’. The determination expression indicates that the state of the logical state element is the state ‘t’ when the state of at least one server of ‘server A’ and ‘server B’ is the state ‘t’ or the state ‘u’. The determination expression also indicates that the state of the logical state element is the state ‘f’ when both states of the servers of ‘server A’ and ‘server B’ are the state ‘f’.

The model expansion unit 120 transmits the model information indicating the expanded models to the state transition diagram generation unit 150. The state transition diagram generation unit 150 generates a state transition diagram of the entirety of the system on the basis of the received model information.

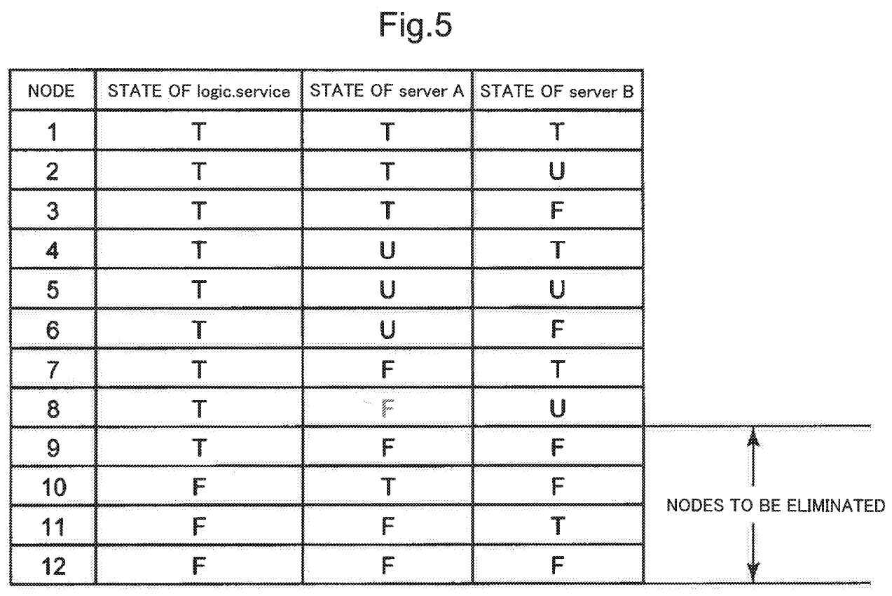

FIG. 5 is an explanatory view illustrating an example of nodes generated by the state transition diagram generation unit 150. Each of the nodes 1 to 12 illustrated in FIG. 5 includes the state of ‘logic.service’, the state of ‘server A’, and the state of ‘server B’. The state of ‘config C’ and the state of ‘config D’ are omitted.

The nodes illustrated in FIG. 5 are elements included in a subset of a Cartesian product concerning all of the states that any the components of the system may take. Therefore, a node to be eliminated based on a determination result of the logical state evaluation unit 140 is also included. The nodes 9 to 12 illustrated in FIG. 5 are nodes to be eliminated based on a determination result.

As illustrated in FIG. 2, the transient state requirement requires that a state of a logical state element be the state ‘t’. When the state transition diagram generation unit 150 generates combinations of states of components of the system (that is, the nodes included in the state transition diagram), the logical state evaluation unit 140 calculates a logical disjunction of the states of ‘server A’ and ‘server B’ included in each of the nodes, and identifies a node where the calculation result is false. The nodes 9 to 12 illustrated in FIG. 5 are nodes where a result of calculation by the logical state evaluation unit 140 is false.

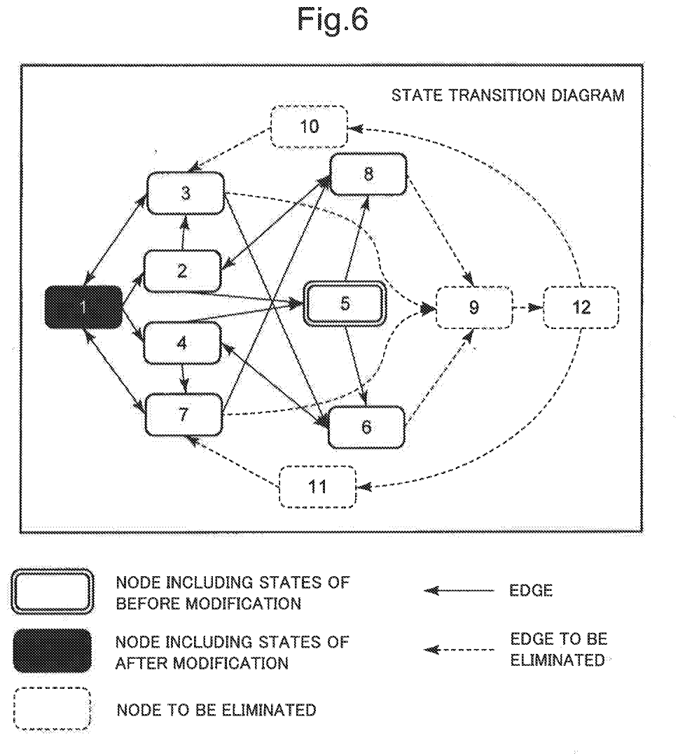

FIG. 6 is an explanatory view illustrating an example of a state transition diagram generated by the state transition diagram generation unit 150. In FIG. 6, a rounded rectangle in a double line represents a node including states of before modification, a black rounded rectangle represents a node including states of after modification, and a rounded rectangle in a broken line represents a node to be eliminated. In FIG. 6, an arrow represents an edge, and an arrow in a broken line represents an edge to be eliminated.

The state transition diagram illustrated in FIG. 6 is a state transition diagram generated by the state transition diagram generation unit 150 on the basis of the nodes illustrated in FIG. 5. Therefore, the state transition diagram illustrated in FIG. 6 includes a node to be eliminated on the basis of the result of determination by the logical state evaluation unit 140 and an edge to be eliminated in addition to a node.

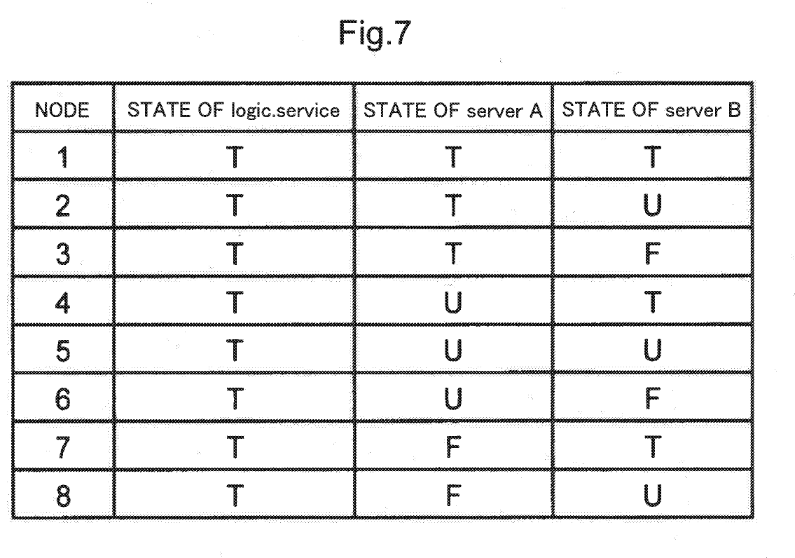

FIG. 7 is an explanatory view illustrating another example of nodes generated by the state transition diagram generation unit 150. The nodes illustrated in FIG. 7 do not include nodes that are eliminated on the basis of the result of determination by the logical state evaluation unit 140, that is, the nodes 9 to 12.

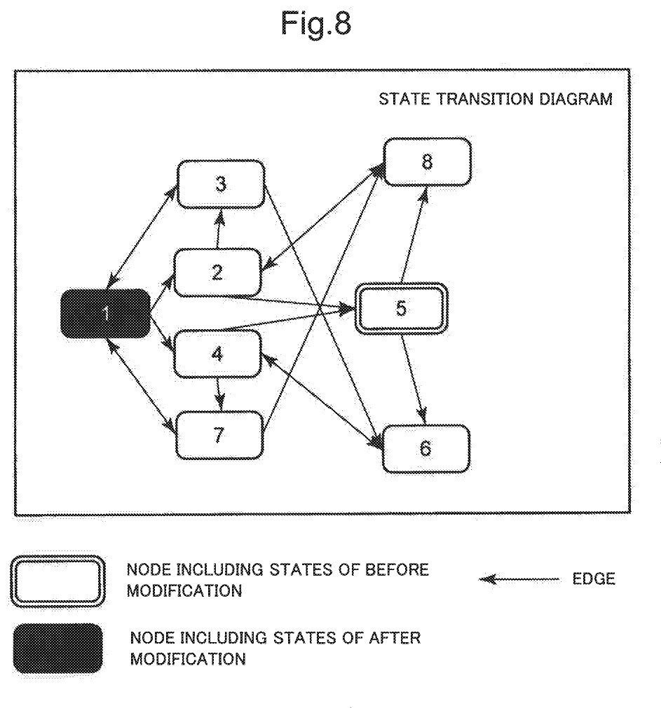

FIG. 8 is an explanatory view illustrating another example of a state transition diagram generated by the state transition diagram generation unit 150. The meanings of the signs in FIG. 8 is similar to the meanings of the signs in FIG. 6.

The state transition diagram illustrated in FIG. 8 is a state transition diagram that is generated by the state transition diagram generation unit 150 on the basis of the nodes illustrated in FIG. 7. Therefore, the state transition diagram illustrated in FIG. 8 does not include nodes that are eliminated on the basis of the result of determination by the logical state evaluation unit 140 nor edges eliminated with the nodes.

After generating the state transition diagram as illustrated in FIG. 8, the state transition diagram generation unit 150 transmits the generated state transition diagram to the procedure deriving unit 160. The procedure deriving unit 160 derives a modification procedure on the basis of the received state transition diagram. After deriving the modification procedure, the procedure deriving unit 160 transmits the derived modification procedure to the output device 300.

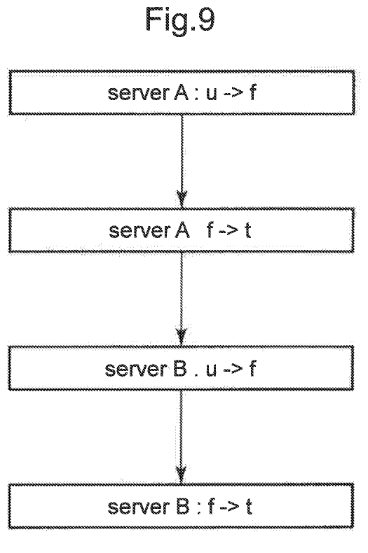

FIG. 9 is an explanatory view illustrating an example of the modification procedure derived from the input information by the procedure deriving unit 160. The modification procedure illustrated in FIG. 9 is a modification procedure for the modification requirement represented by the input information illustrated in FIG. 2.

Each of the rectangles illustrated in FIG. 9 corresponds to one operation included in a modification procedure. For example, the term “server A: u->f” is described in a first rectangle. The first operation of the modification procedure is an operation of changing the state of ‘server A’ from the state ‘u’ to the state ‘f’. In the modification procedure illustrated in FIG. 9, operations for ‘config C’ and ‘config D’ are omitted.

The modification procedure illustrated in FIG. 9 does not include an operation where the state of ‘server A’ and the state of ‘server B’ simultaneously become the state ‘f’. This is because a node that does not satisfy the transient state requirement that is input is eliminated from the state transition diagram.

In accordance with the modification procedure illustrated in FIG. 9, the servers are updated in order. The output device 300 outputs the modification procedure illustrated in FIG. 9 for the input information illustrated in FIG. 2.

### (Description of Operation)

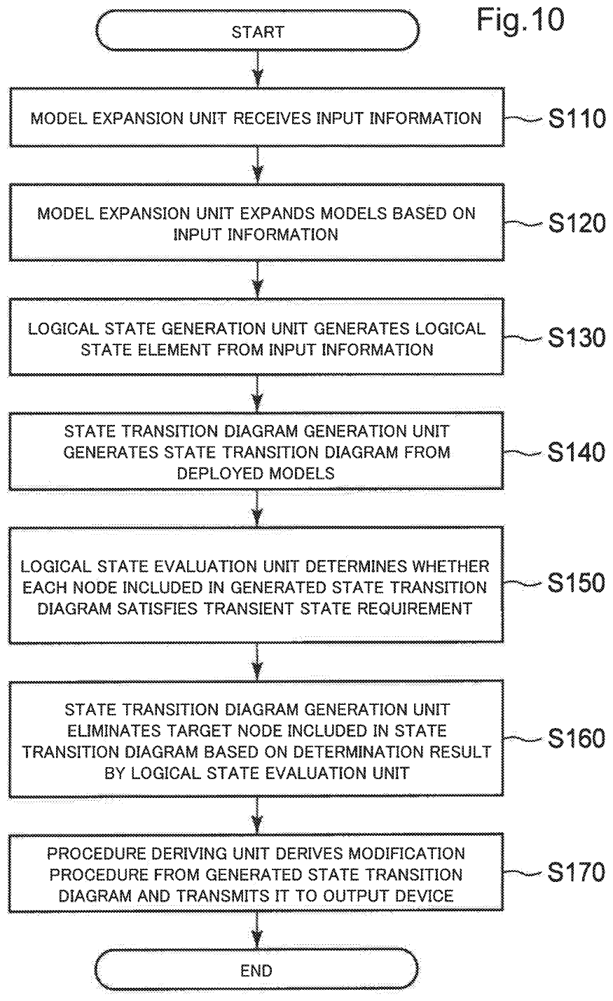

The following describes the operation of generating a modification procedure by the modification procedure generation device 100 of the present example embodiment with reference to FIG. 10. FIG. 10 is a flowchart illustrating the operation of modification procedure generation processing by the modification procedure generation device 100 of the present example embodiment.

When input information representing a modification requirement is input, the input device 200 transmits the input information to the model expansion unit 120. In other words, the model expansion unit 120 receives the input information (step S110).

Next, the model expansion unit 120 expands models on the basis of the received input information (step S120). The model expansion unit 120 refers to information managed by the model management unit 110 for expanding the models.

Next, the model expansion unit 120 transmits model information indicating the expanded models to the state transition diagram generation unit 150. Further, the model expansion unit 120 transmits the received information indicating a logical state element and a transient state requirement to the logical state generation unit 130.

Next, the logical state generation unit 130 generates a logical state element on the basis of the received information (step S130). The logical state generation unit 130 refers to information managed by the model management unit 110 for generating the logical state element.

Next, the state transition diagram generation unit 150 generates a state transition diagram of the entirety of the system on the basis of the received model information (step S140). After generating the state transition diagram, the state transition diagram generation unit 150 transmits each of the nodes included in the state transition diagram to the logical state evaluation unit 140.

Next, the logical state evaluation unit 140 determines whether a node satisfies the transient state requirement for each of the nodes that are received (step S150). The logical state evaluation unit 140 transmits the result of determination for each of the nodes to the state transition diagram generation unit 150.

Next, the state transition diagram generation unit 150 eliminates a node that does not satisfy the transient state requirement from the state transition diagram on the basis of the received result of determination (step S160). The state transition diagram generation unit 150 further eliminates an edge related to the node that is eliminated together with the node from the state transition diagram. After eliminating a node and an edge as a target, the state transition diagram generation unit 150 transmits the state transition diagram to the procedure deriving unit 160.

Next, the procedure deriving unit 160 derives a modification procedure on the basis of the received state transition diagram. After deriving the modification procedure, the procedure deriving unit 160 transmits the derived modification procedure to the output device 300 (step S170). After transmitting the derived modification procedure, the modification procedure generation device 100 ends processing of generating the modification procedure.

(Advantageous Effects of the Invention)

Using the modification procedure generation device of the present example embodiment, by only specifying states of components of the system of before and after modification and a predefined general requirement of during modification, a user can generate a modification procedure that is appropriate for a system modification and satisfies the requirement of during modification.

This is because the logical state evaluation unit determines whether a node including the states under modification of components of a system satisfies a specified requirement of during modification, and the state transition diagram generation unit eliminates a node that does not satisfy the requirement of under modification from the state transition diagram on the basis of the result of determination.

### Second Example Embodiment

(Description of Configuration)

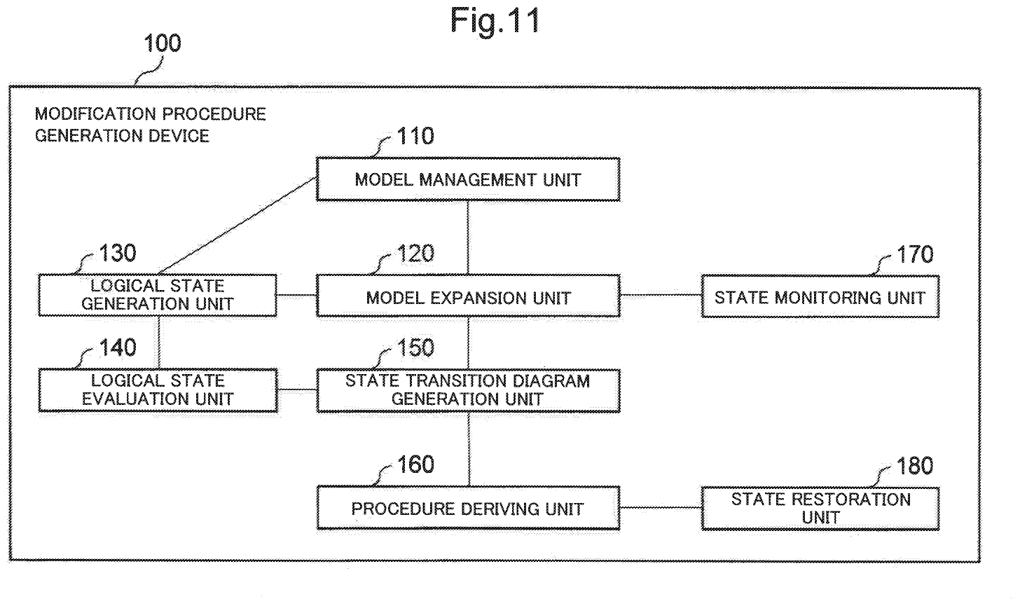

The following describes a second example embodiment of the present invention with reference to the drawings. FIG. 11 is a block view illustrating a configuration example of a modification procedure generation device 100 according to the second example embodiment of the present invention. As illustrated in FIG. 11, the modification procedure generation device 100 of the present example embodiment includes a model management unit 110, a model expansion unit 120, a logical state generation unit 130, a logical state evaluation unit 140, a state transition diagram generation unit 150, a procedure deriving unit 160, a state monitoring unit 170, and a state restoration unit 180.

The configuration of the modification procedure generation device 100 illustrated in FIG. 11 is the same as the configuration of the modification procedure generation device 100 illustrated in FIG. 1 except for the state monitoring unit 170 and state restoration unit 180. The state monitoring unit 170 and the state restoration unit 180 are components used in place of the input device 200 and the output device 300.

The modification procedure generation device 100 of the present example embodiment monitors a current state of a component of a system generates a restoration procedure that satisfies a transient state requirement set in advance when a state of a components is modified due to some cause. Next, the modification procedure generation device 100 restores the states of the components in accordance with the generated restoration procedure.

The state monitoring unit 170 has a function of monitoring the state of a system that is a target of monitoring. When the state of the system that is a target of monitoring is changed, the state monitoring unit 170 detects a change in the state. Having detected the change in the state, the state monitoring unit 170 requests the model expansion unit 120 to generate a system restoration procedure.

When requesting generation of a system restoration procedure, the state monitoring unit 170 transmits failure information to the model expansion unit 120. The failure information includes the state of after detecting a change as a state of before modification and the state of before detecting a change as a state of after modification. Further, the failure information includes a transient state requirement that is set in advance in the state monitoring unit 170.

The procedure deriving unit 160 transmits the derived restoration procedure to the state restoration unit 180. The state restoration unit 180 has a function of restoring a state of a component on the basis of the received restoration procedure.

(Description of Operation)

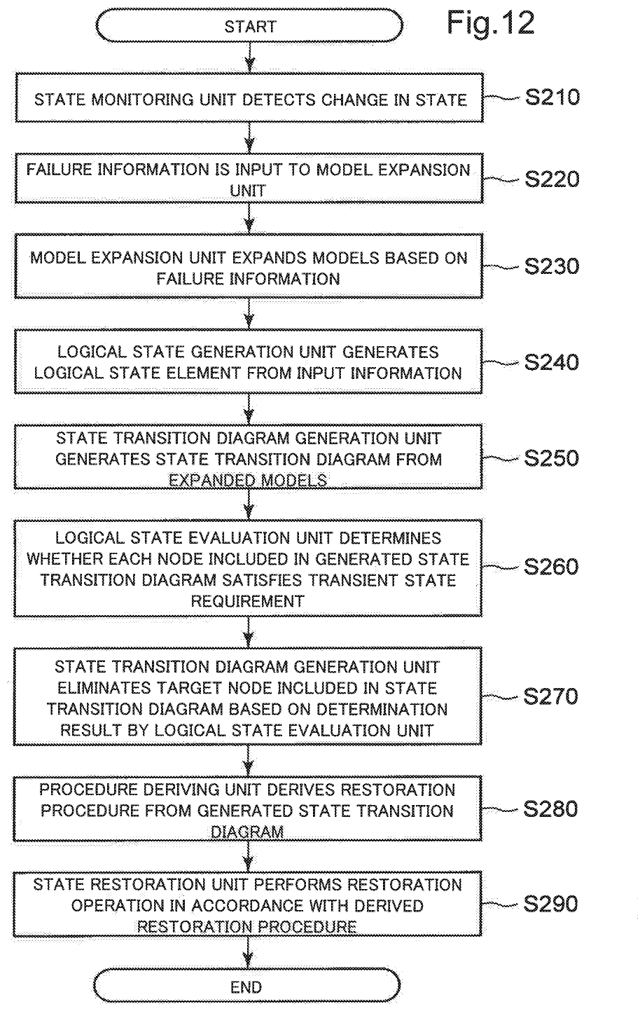

The following describes operation of restoring the state of a component by the modification procedure generation device 100 of the present example embodiment with reference to FIG. 12. FIG. 12 is a flowchart illustrating the operation of processing of restoring by the modification procedure generation device 100 of the present example embodiment.

The state monitoring unit 170 detects a change in a state of a component of a system (step S210). Next, the state monitoring unit 170 requests the model expansion unit 120 to generate a system restoration procedure. In other words, failure information is input to the model expansion unit 120 (step S220).

Next, the model expansion unit 120 expands models on the basis of the input failure information (step S230).

The processing of steps S240 to S270 is similar to the processing of steps S130 to S160 of the first example embodiment.

The procedure deriving unit 160 derives a restoration procedure on the basis of the received state transition diagram (step S280). After deriving the restoration procedure, the procedure deriving unit 160 transmits the derived restoration procedure to the state restoration unit 180.

The state restoration unit 180 restores the state of the component in accordance with the received restoration procedure (step S290). After restoring the state of the component, the modification procedure generation device 100 ends the processing of restoring.

(Advantageous Effects of the Invention)

The modification procedure generation device of the present example embodiment is capable of performing a restoration operation of the system when a failure in a system is detected, for example, while maintaining a predefined service level. This is because the state monitoring unit inputs a transient state requirement for a service level or the like to the model expansion unit, the procedure deriving unit derives a restoration procedure that always satisfies the input transient state requirement, and the state restoration unit is capable of performing a restoration operation in accordance with the derived restoration procedure.

The modification procedure generation device 100 of the present example embodiment is achieved, for example, by a processor, such as a Central Processing Unit (CPU) that executes processing in accordance with a program stored in a storage medium. That is, the model management unit 110, the model expansion unit 120, the logical state generation unit 130, the logical state evaluation unit 140, the state transition diagram generation unit 150, the procedure deriving unit 160, the state monitoring unit 170, and the state restoration unit 180 are achieved, for example, by the CPU that executes processing under control of the program.

Each unit of the modification procedure generation device 100 of the present example embodiment may also be achieved by a hardware circuit.

### Third Example Embodiment

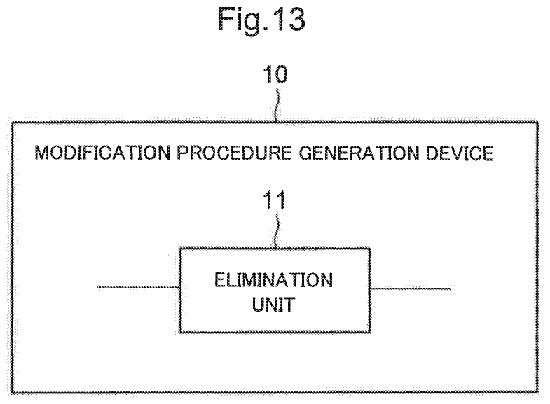

The following describes a third example embodiment of the present invention. FIG. 13 is a block view illustrating an overview of a modification procedure generation device according to the present example embodiment. The modification procedure generation device 10 of the present example embodiment includes an elimination unit 11 that eliminates states other than states that satisfy a predetermined condition from states including states of elements of a system undergoing modification based on a predetermined modification requirement. The predetermined condition is pertaining to the system undergoing modification. The states may be, for example, the nodes described above. The elimination unit 11 is, for example, the state transition diagram generation unit 150 described above.

By such a configuration, the modification procedure generation device according to the present example embodiment is capable of generating a modification procedure taking into account a requirement for a system in the midst of modification.

Further, the modification procedure generation device 10 may include a determination unit (for example, the logical state evaluation unit 140) that determines whether states satisfy a predetermined condition.

By such a configuration, the modification procedure generation device according to the present example embodiment is capable of eliminating a node included in a state transition diagram on the basis of a result of determination using a transient state requirement by the logical state evaluation unit.

Furthermore, the states may include a state of an entirety of the system. The determination unit may determine whether or not the state of the entirety of the system satisfies a predetermined condition.

By such a configuration, the modification procedure generation device according to the present example embodiment is capable of generating a modification procedure that allows a system to continue providing services even during an operation of modification.

The modification procedure generation device 10 may include a state group generation unit (for example, the state transition diagram generation unit 150) that generates the states on the basis of a predetermined modification requirement and information indicating a system

By such a configuration, the modification procedure generation device according to the present example embodiment is capable of generating a state transition diagram that includes nodes including the states that the components of the system may take.

The modification procedure generation device 10 may also include a procedure generation unit (for example, the procedure deriving unit 160) that generates a modification procedure for a predetermined modification requirement on the basis of the states.

By such a configuration, the modification procedure generation device according to the present example embodiment is capable of generating a modification procedure on the basis of only nodes that satisfy a transient state requirement.

The modification procedure generation device 10 may further include a restoration unit (for example, the state restoration unit 180) that restores the system. The predetermined modification requirement may be a requirement for modifying the system in which a failure has occurred into the system of before occurrence of the failure. The procedure generation unit may generate a modification procedure (for example, the restoration procedure) for the predetermined modification requirement. The restoration unit may restore the system in accordance with the generated modification procedure.

By such a configuration, the modification procedure generation device according to the present example embodiment is capable of generating a restoration procedure for restoring a system in which a failure has occurred.

### Other Example Embodiments

As described above, the modification procedure generation devices according to the example embodiments of the present invention can be achieved by a computer that includes a memory into which a program is loaded and a processor that executes the program loaded in the memory. The modification procedure generation devices according to the example embodiments of the present invention can be achieved by dedicated hardware, such as a circuit. The modification procedure generation devices according to the example embodiments of the present invention can also be achieved by a combination of the above-described computer and dedicated hardware.

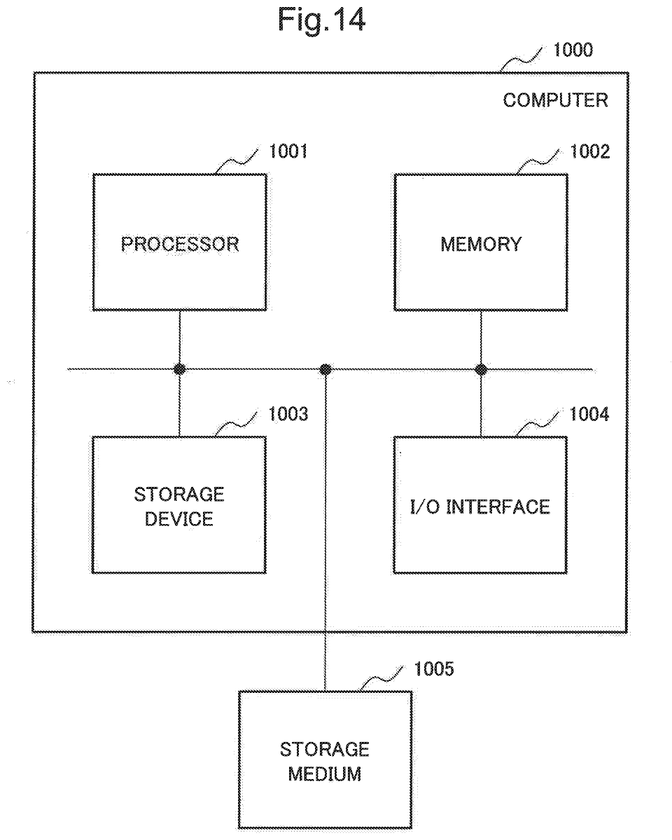

FIG. 14 is a block view representing a hardware configuration of a computer that can achieve the modification procedure generation devices (the modification procedure generation devices 100 and the modification procedure generation device 10) according to the example embodiments of the present invention. In FIG. 14, the computer 1000 includes a processor 1001, a memory 1002, a storage device 1003, and an I/O (Input/Output) interface 1004. The computer 1000 can access a storage medium 1005. The memory 1002 and the storage device 1003 may be storage devices, such as a Random Access Memory (RAM) and a hard disk. The storage medium 1005 is, for example, a storage device, such as a RAM or a hard disk, a Read Only Memory (ROM), or a portable storage medium. The storage device 1003 may be the storage medium 1005. The processor 1001 can read and write data and a program from and into the memory 1002 and the storage device 1003. The processor 1001 can access, for example, the input device 200 and the output device 300 via the I/O interface 1004. The processor 1001 can access the storage medium 1005.

The storage medium 1005 may store a program that causes the computer 1000 to operate, for example, as the modification procedure generation device 100. In other words, the storage medium 1005 may store a program that achieves the functions of the model management unit 110, the model expansion unit 120, the logical state generation unit 130, the logical state evaluation unit 140, the state transition diagram generation unit 150, and the procedure deriving unit 160. The program stored in the storage medium 1005 may further achieve the functions of the state monitoring unit 170 and the state restoration unit 180.

The processor 1001 loads a program stored in the storage medium 1005 into the memory 1002. The processor 1001 executes the program loaded in the memory 1002. Then, the computer 1000 operates as the modification procedure generation device 100. That is, the model management unit 110, the model expansion unit 120, the logical state generation unit 130, the logical state evaluation unit 140, the state transition diagram generation unit 150, and the procedure deriving unit 160 can be achieved by the memory 1002 into which the above-described program is loaded and the processor 1001 that executes the program. Similarly, the state monitoring unit 170 and the state restoration unit 180 can be achieved by the memory 1002 into which the above-described program is loaded and the processor 1001 that executes the program.

The model management unit 110, the model expansion unit 120, the logical state generation unit 130, the logical state evaluation unit 140, the state transition diagram generation unit 150 and the procedure deriving unit 160 can be achieved also by a dedicated circuit. Similarly, the state monitoring unit 170 and the state restoration unit 180 can be achieved by a dedicated circuit. The model management unit 110, the model expansion unit 120, the logical state generation unit 130, the logical state evaluation unit 140, the state transition diagram generation unit 150 and the procedure deriving unit 160 can be achieved also by a combination of the above-described processor 1001 and memory 1002 and the dedicated circuit. Similarly, the state monitoring unit 170 and the state restoration unit 180 can be achieved by a combination of the above-described processor 1001 and memory 1002 and the dedicated circuit.

The storage medium 1005 may store a program that causes the computer 1000 to operate, for example, as the modification procedure generation device 10. In other words, the storage medium 1005 may store, for example, a program that achieves the function of the generation unit 11. The processor 1001 loads the program stored in the storage medium 1005 into the memory 1002. The processor 1001 executes the program loaded in the memory 1002. Then, the computer 1000 operates as the modification procedure generation device 10. That is, the generation unit 11 can be achieved by the memory 1002 into which the above-described program is loaded and the processor 1001 that executes the program. The generation unit 11 can be achieved by a dedicated circuit. The generation unit 11 can be achieved also by a combination of the above-described processor 1001 and memory 1002 and the dedicated circuit.

A part or all of the example embodiments described above may be described also as the following Supplemental Notes but is not limited thereto.

(Supplementary Notes 1)

The modification procedure generation device including elimination means for eliminating states other than states that satisfy a predetermined condition from states including states of elements of a system undergoing modification based on a predetermined modification requirement, the predetermined condition pertaining to the system undergoing modification.

(Supplementary Notes 2)

The modification procedure generation device according to claim 1, further including:

determination means for determining whether or not the states satisfy the predetermined condition.

(Supplementary Notes 3)

The modification procedure generation device according to claim 2, wherein

the states include a state of an entirety of the system, and

the determination means determines whether the state of the entirety of the system satisfies a predetermined condition.

(Supplementary Notes 4)

The modification procedure generation device according to any one of claims 1 to 3, further including

state group generation means for generating the states based on the predetermined modification requirement and information indicating the system.

(Supplementary Notes 5)

The modification procedure generation device according to any one of claims 1 to 4, including

procedure generation means for generating a modification procedure for the predetermined modification requirement based on the states.

(Supplementary Notes 6)

The modification procedure generation device according to claim 5, including

restoration means for restoring the system, wherein

the predetermined modification requirement is a requirement for modifying the system in which a failure has occurred into the system of before occurrence of the failure,

the procedure generation means generates the modification procedure for the predetermined modification requirement, and

the restoration means restores the system in accordance with the generated modification procedure.

(Supplementary Notes 7)

A modification procedure generation method including

eliminating states other than states that satisfy a predetermined condition from states including states of elements of a system undergoing modification based on a predetermined modification requirement, the predetermined condition pertaining to the system undergoing modification.

(Supplementary Notes 8)

The modification procedure generation method according to claim 7, further including

determining whether or not the states satisfy the predetermined condition.

(Supplementary Notes 9)

The modification procedure generation method according to claim 8, wherein

the states includes a state of a entirety of the system, and

the determining determines whether the state of the the entirety of the system satisfies a predetermined condition.

(Supplementary Notes 10)

The modification procedure generation method according to any one of claims 7 to 9, further including

generating the states based on the predetermined modification requirement and information indicating the system.

(Supplementary Notes 11)

The modification procedure generation method according to any one of claims 7 to 10, further including

generating a modification procedure for the predetermined modification requirement based on the states.

(Supplementary Notes 12)

The modification procedure generation method according to claim 11, further including

restoring the system, wherein

the predetermined modification requirement is a requirement for modifying the system in which a failure has occurred into the system of before occurrence of the failure,

the generating the modification procedure generates the modification procedure for the predetermined modification requirement, and

the restoring includes restoring the system in accordance with the generated modification procedure.

(Supplementary Notes 13)

A storage medium storing a modification procedure generation program that causes a computer to execute

elimination processing of eliminating states other than states that satisfy a predetermined condition from states including states of elements of a system undergoing modification based on a predetermined modification requirement, the predetermined condition pertaining to the system undergoing modification.

(Supplementary Notes 14)

The storage medium according to claim 13, the storage medium storing the modification procedure generation program that causes a computer to execute

determination processing of determining whether or not the states satisfy the predetermined condition.

(Supplementary Notes 15)

The storage medium according to claim 14, the storage medium storing the modification procedure generation program, wherein

the states include a state of an entirety of the system, and

the determination processing determines whether the state of the entirety of the system satisfies a predetermined condition.

(Supplementary Notes 16)

The storage medium according to any one of claims 13 to 15, the storage medium storing the modification procedure generation program that causes a computer to execute

state group generation processing of generating the states based on the predetermined modification requirement and information indicating the system.

(Supplementary Notes 17)

The storage medium according to any one of claims 13 to 16, the storage medium storing the modification procedure generation program that causes a computer to execute

procedure generation processing of generating a modification procedure for the predetermined modification requirement, based on the states.

(Supplementary Notes 18)

The storage medium according to claim 17, the storage medium storing the modification procedure generation program that causes a computer to execute

restoration processing of restoring the system, wherein

the predetermined modification requirement is a requirement for modifying the system in which a failure has occurred into the system of before occurrence of the failure,

the procedure generation processing generates the modification procedure for the predetermined modification requirement, and

the restoration processing restores the system in accordance with the generated modification procedure.

The claimed invention has been described so far with reference to the above-described example embodiments and examples but is not limited thereto. A variety of modifications that will be understood by those skilled in the art can be made to the configuration and details of the claimed invention within the scope thereof.

This application claims priority based on Japanese Patent Application No. 2016-046526 filed on Mar. 10, 2016, the disclosure of which is incorporated herein in its entirety by reference.

### INDUSTRIAL APPLICABILITY

The present invention is preferably applicable to the purpose of editing a system configuration definition. In addition, the present invention is preferably applicable to a tool product that determines a deployment operation required for the operation of components and performs the deployment by only making a combination of the components, such as a server and an application, of a system.

### REFERENCE SIGNS LIST

10, 100 Modification procedure generation device
11 Elimination unit
110 Model management unit
120 Model expansion unit
130 Logical state generation unit
140 Logical state evaluation unit
150 State transition diagram generation unit
160 Procedure deriving unit
170 State monitoring unit
180 State restoration unit
200 Input device
300 Output device
1000 Computer
1001 Processor
1002 Memory
1003 Storage device
1004 I/O interface
1005 Storage medium

What is claimed is:

1. The modification procedure generation device comprising:
a memory that stores a set of instructions; and
at least one processor configured to execute the set of instructions to
eliminate states other than states that satisfy a predetermined condition from states including states of elements of a system undergoing modification based on a predetermined modification requirement, the predetermined condition pertaining to the system undergoing modification.

2. The modification procedure generation device according to claim 1, wherein
the at least one processor is configured to
determine whether or not the states satisfy the predetermined condition.

3. The modification procedure generation device according to claim 2, wherein
the states include a state of an entirety of the system, and
the at least one processor is configured to
determine whether the state of the entirety of the system satisfies a predetermined condition.

4. The modification procedure generation device according to claim 1, wherein
the at least one processor is configured to
generate the states based on the predetermined modification requirement and information indicating the system.

5. The modification procedure generation device according to claim 1, wherein
the at least one processor is configured to
generate a modification procedure for the predetermined modification requirement based on the states.

6. The modification procedure generation device according to claim 5, wherein
the predetermined modification requirement is a requirement for modifying the system in which a failure has occurred into the system of before occurrence of the failure, and
the at least one processor is further configured to:
generate the modification procedure for the predetermined modification requirement; and
restore the system in accordance with the generated modification procedure.

7. A modification procedure generation method comprising
eliminating states other than states that satisfy a predetermined condition from states including states of elements of a system undergoing modification based on a predetermined modification requirement, the predetermined condition pertaining to the system undergoing modification.

8. The modification procedure generation method according to claim 7, further comprising
determining whether or not the states satisfy the predetermined condition.

9. The modification procedure generation method according to claim 8, wherein
the states includes a state of a entirety of the system, and
the determining determines whether the state of the entirety of the system satisfies a predetermined condition.

10. The modification procedure generation method according to claim 7, further comprising
generating the states based on the predetermined modification requirement and information indicating the system.

11. The modification procedure generation method according to claim 7, further comprising
generating a modification procedure for the predetermined modification requirement based on the states.

12. The modification procedure generation method according to claim 11, further comprising
restoring the system, wherein
the predetermined modification requirement is a requirement for modifying the system in which a failure has occurred into the system of before occurrence of the failure,
the generating the modification procedure generates the modification procedure for the predetermined modification requirement, and
the restoring includes restoring the system in accordance with the generated modification procedure.

13. A non-transitory computer readable storage medium storing a modification procedure generation program that causes a computer to execute:
elimination processing of eliminating states other than states that satisfy a predetermined condition from states including states of elements of a system undergoing modification based on a predetermined modification requirement, the predetermined condition pertaining to the system undergoing modification.

14. The storage medium according to claim 13, the storage medium storing the modification procedure generation program that causes a computer to execute:
determination processing of determining whether or not the states satisfy the predetermined condition.

15. The storage medium according to claim 14, the storage medium storing the modification procedure generation program, wherein
the states include a state of an entirety of the system, and
the determination processing determines whether the state of the entirety of the system satisfies a predetermined condition.

16. The storage medium according to claim 13, the storage medium storing the modification procedure generation program that causes a computer to execute
state group generation processing of generating the states based on the predetermined modification requirement and information indicating the system.

17. The storage medium according to claim 13, the storage medium storing the modification procedure generation program that causes a computer to execute
procedure generation processing of generating a modification procedure for the predetermined modification requirement, based on the states.

18. The storage medium according to claim 17, the storage medium storing the modification procedure generation program that causes a computer to execute
restoration processing of restoring the system, wherein
the predetermined modification requirement is a requirement for modifying the system in which a failure has occurred into the system of before occurrence of the failure,
the procedure generation processing generates the modification procedure for the predetermined modification requirement, and
the restoration processing restores the system in accordance with the generated modification procedure.
